(19) United States
(12) Patent Application Publication
(10) Pub. No.: US 2020/0111345 A1
(43) Pub. Date: Apr. 9, 2020

(54) USER BEHAVIOR MONITORING METHOD AND WEARABLE DEVICE

(71) Applicant: GOERTEK. INC,, Shandong Province (CN)

(72) Inventors: Yan Li, Shandong Province (CN); Dachuan Zhao, Shandong Province (CN); Xin Zhao, Shandong Province (CN); Waner Liu, Shandong Province (CN)

(21) Appl. No.: 16/469,447

(22) PCT Filed: Jul. 21, 2017
(86) PCT No.: PCT/CN2017/093882

§ 371 Date: Jun. 13, 2019

(30) Foreign Application Priority Data
Dec. 15, 2016 (CN) 201611163160.3

(51) Int. Cl. G08B 31/00; H04B 1/3827; G08B 29/18; G08B 21/04; G08B 3/10; G08B 25/10

(52) U.S. Cl. CPC G08B 31/00; H04B 1/385; G08B 25/10; G08B 21/0423; G08B 3/1033; G08B 29/185

(57) ABSTRACT

A user behavior monitoring method and a wearable device are provided. The method comprises: providing an inertial sensor in a wearable device; at the beginning of each data indicator acquiring phases, after a user has worn the wearable device, monitoring and collecting historical movement data of the user in a preset statistical period by the inertial sensor, and acquiring a predictive indicator according to a changing trend of the historical movement data; in real-time monitoring, collecting real-time movement data of the user, and judging whether the user has an abnormal behavior according to the real-time movement data, the predictive indicator acquired in the data indicator acquiring phase and a preset strategy; and sending an alarm notification when it is determined that the user has an abnormal behavior. The device can perform customized and high-accuracy behavior monitoring with respect to different users.

### CROSS REFERENCE TO RELATED APPLICATIONS

This Application is a U.S. National Stage entry under 35 U.S.C. § 371 based on International Application No. PCT/CN2017/093882, filed on Jul. 21, 2017, which was published under PCT Article 21(2) and which claims priority to Chinese Patent Application No. 201611163160.3, filed on Dec. 15, 2016. These priority applications are hereby incorporated herein in their entirety by reference.

### TECHNICAL FIELD

This Application pertains to the field of wearable smart devices, and in particular to a user behavior monitoring method and a wearable device.

### BACKGROUND

With the rapid development of mobile internet technology, wearable devices are evolving fast and attracting more and more attention and demands. Among them, in order to meet the current trend of caring about fitness and exercise, behavior monitoring functions have been provided in various wearable devices.

However, existing wearable devices generally monitor user behaviors by extracting features from big data information of normal behaviors (such as walking and running) of a similar group of people, and training a unitary classification model. Any behavior not fitting into the unitary classification model will be judged as an abnormal behavior, such as falling and dropping. In this technical solution of the prior art, individual differences of each person are not considered, and since the instantaneous characteristic information of some normal behaviors (such as running and going down the stairs) is similar to the characteristic information of abnormal behaviors, misjudgments may occur very often. In addition, other objects, desirable features and characteristics will become apparent from the subsequent summary and detailed description, and the appended claims, taken in conjunction with the accompanying drawings and this background.

### SUMMARY

In view of the above problems, the present disclosure provides a user behavior monitoring method and a wearable device to solve or at least partially solve the above problems.

According to an aspect of the present disclosure, a user behavior monitoring method is provided, which comprises:

providing an inertial sensor in a wearable device;

at the beginning of each data indicator acquiring phases, after a user has worn the wearable device, monitoring and collecting historical movement data of the user in a preset statistical period by the inertial sensor, and acquiring a predictive indicator according to a changing trend of the historical movement data;

in real-time monitoring, collecting real-time movement data of the user, and judging whether the user has an abnormal behavior according to the real-time movement data, the predictive indicator acquired in the data indicator acquiring phase and a preset strategy; and

sending an alarm notification when it is determined that the user has an abnormal behavior.

Optionally, the preset statistical period consists of a plurality of sub-periods;

the step of collecting historical movement data of the user in a preset statistical period comprises: collecting movement data in each sub-period in the preset statistical period;

the step of acquiring a predictive indicator according to a changing trend of the historical movement data comprises: acquiring the predictive indicator in a current sub-period according to the changing trend of the movement data in a plurality of consecutive sub-periods; and

the step of collecting real-time movement data of the user comprises: collecting real-time movement data in the current sub-period.

Optionally, each sub-period consists of a plurality of time intervals;

the step of acquiring the predictive indicator in a current sub-period according to the changing trend of the movement data in a plurality of consecutive sub-periods comprises:

acquiring movement data in a specified time interval of each sub-period; and

predicting the predictive indicator in the specified time interval in the current sub-period according to a changing trend of the movement data in the specified time intervals in the plurality of sub-periods; and

the step of collecting real-time movement data in the current sub-period comprises: collecting real-time movement data in the specified time interval in the current sub-period.

Optionally, the step of judging whether the user has an abnormal behavior according to the real-time movement data, the predictive indicator acquired in the data indicator acquiring phase and a preset strategy comprises:

calculating a relevant parameter of the real-time movement data according to the real-time movement data; and

comparing the real-time movement data with the predictive indicator, and determining that the user has an abnormal behavior when the real-time movement data exceed a predetermined range of the predictive indicator and the real-time movement data and/or the relevant parameter of the real-time movement data satisfy a predetermined condition.

Optionally, the inertial sensor comprises: an accelerometer configured to collect accelerations/an acceleration in an x-axis direction, a y-axis direction and/or a z-axis direction of the user;

the step of acquiring a predictive indicator according to a changing trend of the historical movement data comprises: acquiring a predicted maximum value, a predicted minimum value, and/or a predicted average value of the accelerations/acceleration in the x-axis direction, the y-axis direction and/or the z-axis direction according to a changing trend of the accelerations/acceleration in the x-axis direction, the y-axis direction and/or the z-axis direction in a preset statistical period; and

the step of judging whether the user has an abnormal behavior according to the real-time movement data, the predictive indicator acquired in the data indicator acquiring phase and a preset strategy comprises:

obtaining a real-time speed of the user by calculating according to the accelerations/acceleration in the x-axis direction, the y-axis direction and/or the z-axis direction of the user monitored in real time; and

when a magnitude of the acceleration in the z-axis direction monitored in real time exceeds the predicted maximum value of the acceleration in the z-axis direction, the direction of the acceleration in the z-axis direction monitored in real time changes from the positive direction of the z-axis direction to the negative direction of the z-axis direction, and the real-time speed of the user becomes 0 and has been maintained for a predetermined duration, determining that the user has fallen;

wherein a gravity vector direction is the z-axis direction, a directly forward direction of the user is the x-axis direction, and the y-axis, the x-axis, and the z-axis constitute a right-handed coordinate system, wherein the right-handed coordinate system changes as the user moves.

Optionally, the inertial sensor further comprises: a gyroscope configured to collect rotational angular velocities/a rotational angular velocity about the x-axis direction, the y-axis direction and/or the z-axis direction of the user; and

the step of judging whether the user has an abnormal behavior according to the real-time movement data, the predictive indicator acquired in the data indicator acquiring phase and a preset strategy comprises:

obtaining a real-time speed of the user by calculating according to the accelerations/acceleration in the x-axis direction, the y-axis direction and/or the z-axis direction of the user monitored in real time;

obtaining a real-time tilt angle of the user by calculating according to the rotational angular velocities/rotational angular velocity about the x-axis direction, the y-axis direction and/or the z-axis direction of the user monitored in real time; and

when a magnitude of the acceleration in the z-axis direction monitored in real time exceeds the predicted maximum value of the acceleration in the z-axis direction, the direction of the acceleration in the z-axis direction monitored in real time changes from the positive direction of the z-axis direction to the negative direction of the z-axis direction, the real-time speed of the user becomes 0 and has been maintained for a predetermined duration, and the real-time tilt angle of the user exceeds a predetermined angle, determining that the user has fallen.

Optionally, the method further comprises: providing a barometer in the wearable device, and monitoring an altitude of the user in real time by the barometer after the user wears the wearable device;

the step of judging whether the user has an abnormal behavior according to the real-time movement data, the predictive indicator acquired in the data indicator acquiring phase and a preset strategy further comprises:

after determining that the user has fallen, further judging whether a decrease in the altitude of the user monitored in real time exceeds a predetermined threshold, and if yes, determining that the user has dropped from a high place.

Optionally, the preset statistical period consists of N consecutive sub-periods preceding the current sub-period, wherein N is a positive integer greater than 1; and

the method further comprises: when an earliest collecting time of the historical movement data is not within the N consecutive sub-periods, deleting the historical movement data collected before the N consecutive sub-periods.

According to another aspect of the present disclosure, a wearable device is provided, which comprises: an inertial sensor and a microprocessor, wherein

the inertial sensor is configured to, after a user has worn the wearable device, collect historical movement data of the user in a preset statistical period, and collect real-time movement data of the user; and

the microprocessor is connected to the inertial sensor, and is configured to acquire a predictive indicator according to a changing trend of the historical movement data; judge whether the user has an abnormal behavior according to the real-time movement data, the predictive indicator acquired in the data indicator acquiring phase and a preset strategy; and send an alarm notification when it is determined that the user has an abnormal behavior.

Optionally, the wearable device further comprises: an alarm circuit comprising an audio codec and a speaker; and

the microprocessor is connected to the alarm circuit and is configured to control the speaker to produce a sound through the audio codec.

Optionally, the wearable device further comprises: an emergency call circuit comprising a radio frequency transceiver, a radio frequency front end module and a radio frequency antenna; and

the microprocessor is connected to the emergency call circuit and is configured to receive or transmit radio frequency signals through the emergency call circuit.

Optionally, the inertial sensor comprises an accelerometer configured to collect accelerations/an acceleration in an x-axis direction, a y-axis direction and/or a z-axis direction of the user; or the inertial sensor comprises the accelerometer and a gyroscope configured to collect rotational angular velocities/a rotational angular velocity about the x-axis direction, the y-axis direction and/or the z-axis direction of the user;

the microprocessor is connected to the accelerometer and is configured to process the accelerations/acceleration in the x-axis direction, the y-axis direction and/or the z-axis direction collected by the accelerometer; and the microprocessor is connected to the gyroscope and is also configured to process the rotational angular velocities/rotational angular velocity in the x-axis direction, the y-axis direction and/or the z-axis direction collected by the gyroscope; and

the wearable device further comprises a barometer configured to monitor an altitude of the user; and the microprocessor is connected to the barometer and is also configured to process altitude data collected by the barometer;

wherein a gravity vector direction is the z-axis direction, a directly forward direction of the user is the x-axis direction, and the y-axis, the x-axis, and the z-axis constitute a right-handed coordinate system, wherein the right-handed coordinate system changes as the user moves.

Accordingly, it can be known that, the technical solutions provided by the present disclosure monitor the movement data of the user by the wearable device. For the current moment, the movement data collected by the wearable device in the previous preset statistical period are used as the historical movement data, and the movement data collected in real time by the wearable device at the current moment are used as the real-time movement data. The predictive indicator is acquired according to the change rule of the historical movement data, it is judged whether the user has an abnormal behavior according to the real-time movement data, the predictive indicator and a preset strategy, and an alarm is sent when the judging result is yes. Thereby the monitoring of the behavior of a user wearing a wearable device can be achieved.

The technical solutions can use the historical movement data of each user as the template data of self-learning with respect to different users, and obtain the predictive indicator of the movement at a later time of the user by continuous learning of the template data, and can analyze and discover an abnormal behavior of the user by combining the theoretical predictive indicator and the real-time movement data actually collected at the current moment. Thereby the customized and high accuracy behavior monitoring can be realized.

### BRIEF DESCRIPTION OF DRAWINGS

The present invention will hereinafter be described in conjunction with the following drawing figures, wherein like numerals denote like elements, and:

FIG. 1 shows a flow chart of a user behavior monitoring method according to an embodiment of the present disclosure;

FIG. 2A shows a changing trend diagram of acceleration in the x-axis direction in a preset statistical period according to an embodiment of the present disclosure;

FIG. 2B shows a changing trend diagram of acceleration in the y-axis direction in a preset statistical period according to an embodiment of the present disclosure;

FIG. 2C shows a changing trend diagram of acceleration in the z-axis direction in a preset statistical period according to an embodiment of the present disclosure;

FIG. 2D shows a changing trend diagram of the speed of a user in a preset statistical period according to an embodiment of the present disclosure;

FIG. 3 shows a schematic diagram of a wearable device according to an embodiment of the present disclosure;

FIG. 4 shows a schematic diagram of a wearable device according to another embodiment of the present disclosure; and

FIG. 5 shows a flow chart of monitoring the user behavior by a wearable device according to an embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

In order to make the objectives, technical solutions and advantages of the present disclosure clearer, the present disclosure is further described in detail with reference to the accompanying drawings and the embodiments.

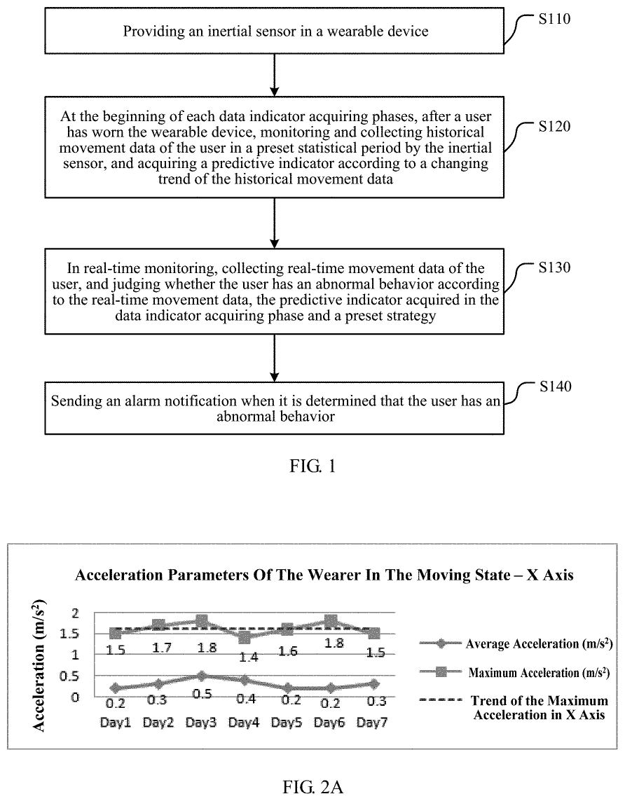

FIG. 1 shows a flow chart of a user behavior monitoring method according to an embodiment of the present disclosure.

As shown in FIG. 1, the method comprises:

Step S110, providing an inertial sensor in a wearable device.

Step S120, at the beginning of each data indicator acquiring phases, after a user has worn the wearable device, monitoring and collecting historical movement data of the user in a preset statistical period by the inertial sensor, and acquiring a predictive indicator according to a changing trend of the historical movement data;

Step S130, in real-time monitoring, collecting real-time movement data of the user, and judging whether the user has an abnormal behavior according to the real-time movement data, the predictive indicator acquired in the data indicator acquiring phase and a preset strategy; and

Step S140, sending an alarm notification when it is determined that the user has an abnormal behavior.

It should be noted that the process of collecting historical movement data in Step S120 and the process of collecting real-time movement data in Step S130 are both implemented based on the function of monitoring movement data of the inertial sensor in the wearable device. There is a certain time difference between the collecting time and the processing time of the historical movement data, but there is almost no time difference between the collecting time and the processing time of the real-time movement data. Specifically, the historical movement data in Step S120 refer to the movement data collected in the preset statistical period before the current moment, while the real-time movement data in Step S130 refer to the movement data collected at the current moment. The current real-time movement data may be used as the historical movement data at a later time. Therefore, the data indicator acquiring phase in Step S120 and the real-time monitoring phase in Step S130 are not divided according to the execution order, but according to the execution contents, and the data indicator acquiring phase and the real-time monitoring phase may be performed simultaneously.

Thus, the method shown in FIG. 1 monitors the movement data of the user by the wearable device. For the current moment, the movement data collected by the wearable device in the previous preset statistical period are used as the historical movement data, and the movement data collected in real time by the wearable device at the current moment are used as the real-time movement data. The predicting indicator is acquired according to the change rule of the historical movement data, it is judged whether the user has an abnormal behavior according to the real-time movement data, the predictive indicator and a preset strategy, and an alarm is sent when the judging result is yes. Thereby the monitoring of the behavior of a user wearing a wearable device can be achieved.

The technical solution can use the historical movement data of each user as the template data of self-learning with respect to different users, and obtain the predictive indicator of the movement at a later time of the user by continuous learning of the template data, and can analyze and discover an abnormal behavior of the user by combining the theoretical predictive indicator and the real-time movement data actually collected at the current moment. Thereby the customized and high accuracy behavior monitoring can be realized.

In an embodiment of the present disclosure, the preset statistical period consists of a plurality of sub-periods. Step S120 of collecting historical movement data of the user in a preset statistical period comprises: collecting movement data in each of the sub-periods in the preset counting cycle. Step S120 of acquiring a predictive indicator according to a changing trend of the historical movement data in the preset statistical period comprises: acquiring the predictive indicator in a current sub-period according to the changing trend of the movement data in a plurality of consecutive sub-periods. Step S130 of collecting real-time movement data of the user comprises: collecting real-time movement data in the current sub-period.

For example, if the preset statistical period is one week, the preset statistical period consists of 7 sub-periods, and each sub-period is one day. For the current sub-period (today), the technical solution uses the movement data in the previous 7 days of the user as the historical movement data, acquires the predictive indicator of the movement of today based on the changing trend of the movement data of the previous 7 days, and judges whether the user has abnormal behavior today according to the real-time movement data collected today, the acquired predictive indicator of the movement of today and a preset strategy.

More preferably, the preset statistical period consists of a plurality of sub-periods, and each sub-period consists of a plurality of time intervals. The step of acquiring the predictive indicator in a current sub-period according to the changing trend of the movement data in a plurality of consecutive sub-periods comprises: acquiring movement data in a specified time interval of each sub-period; and predicting the predictive indicator in the specified time interval in the current sub-period according to the changing trend of the movement data in the specified time intervals in the plurality of sub-periods. The step of collecting real-time movement data in the current sub-period comprises: collecting real-time movement data in the specified time interval in the current sub-period.

For example, the preset statistical period is 7 days, each sub-period is one day, and each sub-period consists of a total of 6 time intervals, namely, 7:00˜8:00, 8:00˜11:00, 11:00˜13:00, 13:00˜16:00, 16:00˜21:00, and 21:00˜7:00. For the current sub-period (today), the movement data in the time interval 7:00˜8:00 of each day in the previous 7 days of the user are acquired, and the predictive indicator of the time interval 7:00˜8:00 of today can be predicted according to the changing trend of the movement data of the time interval 7:00˜8:00 of each days in the previous 7 days. It can be determined whether the user's behavior in the time interval 7:00˜8:00 of today is abnormal according to the real-time movement data collected in the time interval 7:00˜8:00 of today and the predicted predictive indicator of the time interval 7:00˜8:00 of today. It is the same for the other time intervals, so the description thereof will not be repeated here.

Alternatively, in another example, the preset statistical period is 5 weeks, each sub-period is one week and comprises: the time intervals 7:00˜8:00, 8:00˜11:00, 11:00˜13:00, 13:00˜16:00, 16:00˜21:00, 21:00˜7:00 of 5 working days, and the time intervals 8:00˜11:00, 11:00˜13:00, 13:00˜16:00, 16:00˜21:00, 21:00˜8:00 of 2 weekend days. For this Monday of this week, the predictive indicator for the time interval 7:00˜8:00 of this Monday can be predicted according to the changing trend of the movement data of the time interval 7:00˜8:00 each Monday of each week in the previous 5 weeks. It can be determined whether the user's behavior in the time interval 7:00˜8:00 of this Monday is abnormal according to the real-time movement data collected in the time interval 7:00˜8:00 of this Monday and the predicted predictive indicator for the time interval 7:00˜8:00 of this Monday. It is the same for other time intervals, so the description thereof will not be repeated here.

It can be seen that if the duration of the preset statistical period is longer, the sub-periods and the time interval are divided more finely, and the rule of the subsequent movements of the user can be predicted more accurately according to the historical movement data. However, the extension of the preset statistical period and the shortening of the sub-periods or the time interval will inevitably occupy more storage resources of the wearable device and increase the calculation load. Therefore, it is necessary to select a balance point to compromise the two aspects to achieve the most effective monitoring solution.

In an embodiment of the present disclosure, in the method shown in FIG. 1, Step S130 of judging whether the user has an abnormal behavior according to the real-time movement data, the predictive indicator acquired in the data indicator acquiring phase and a preset strategy comprises: calculating a relevant parameter of the real-time movement data according to the real-time movement data; and comparing the real-time movement data with the predictive indicator, and determining that the user has an abnormal behavior when the real-time movement data exceed a predetermined range of the predictive indicator and the real-time movement data and/or the relevant parameter of the real-time movement data satisfy a predetermined condition.

In other words, it is determined that the user has an abnormal behavior when the real-time movement data exceed a predetermined range of the predictive indicator and the real-time movement data satisfy a predetermined condition; or, it is determined that the user has an abnormal behavior when the real-time movement data exceed a predetermined range of the predictive indicator and the relevant parameter of the real-time movement data satisfies a predetermined condition; or, it is determined that the user has an abnormal behavior when the real-time movement data exceed a predetermined range of the predictive indicator, and the real-time movement data and the relevant parameter of the real-time movement data satisfy a predetermined condition.

It will be explained below by a specific example. Assume that a gravity vector direction is the z-axis direction, a directly forward direction of the user is the x-axis direction, the y-axis, the x-axis, and the z-axis constitute a right-handed coordinate system, and the right-handed coordinate system changes as the user moves. In Example 1, the inertial sensor in the wearable device comprises an accelerometer, and after the user has worn the wearable device, the accelerometer is configured to collect accelerations/an acceleration in an x-axis direction, a y-axis direction and/or a z-axis direction of the user.

In Example 1, the Step S120 of acquiring a predictive indicator according to a changing trend of the historical movement data comprises: acquiring a predicted maximum value, a predicted minimum value, and/or a predicted average value of the accelerations/acceleration in the x-axis direction, the y-axis direction and/or the z-axis direction according to a changing trend of the accelerations/acceleration in the x-axis direction, the y-axis direction and/or the z-axis direction in a preset statistical period.

Specifically, the preset statistical period is set to 7 days, and each days is a sub-periods and is divided into a plurality of time intervals. For example, each working days from Monday to Friday is divided into: 7:00˜8:00 as the time interval for exercises, 8:00˜11:00 as the time interval with little movement, 11:00˜13:00 as the time interval for exercises, 13:00˜16:00 as the time interval with little movement, 16:00˜21:00 as the time interval for exercises, and 21:00˜8:00 as the time interval for rest. The difference between Saturday and Sunday and the working days is that 19:00˜20:30 is the time interval for fitness. The acceleration data in each time intervals of each days are collected, valid data are kept and invalid data are removed. The data of the accelerations/acceleration in the x-axis direction, the y-axis direction and/or the z-axis direction in each time intervals in the previous 7 days are taken as the historical movement data, and according to the changing trend of the accelerations/acceleration in the x-axis direction, the y-axis direction and/or the z-axis direction of the same time interval of each days in the previous 7 days, the predicted maximum value, the predicted minimum value, and/or the predicted average value of the accelerations/acceleration in the x-axis direction, the y-axis direction and/or the z-axis direction of the same time interval of the 8th day can be predicted.

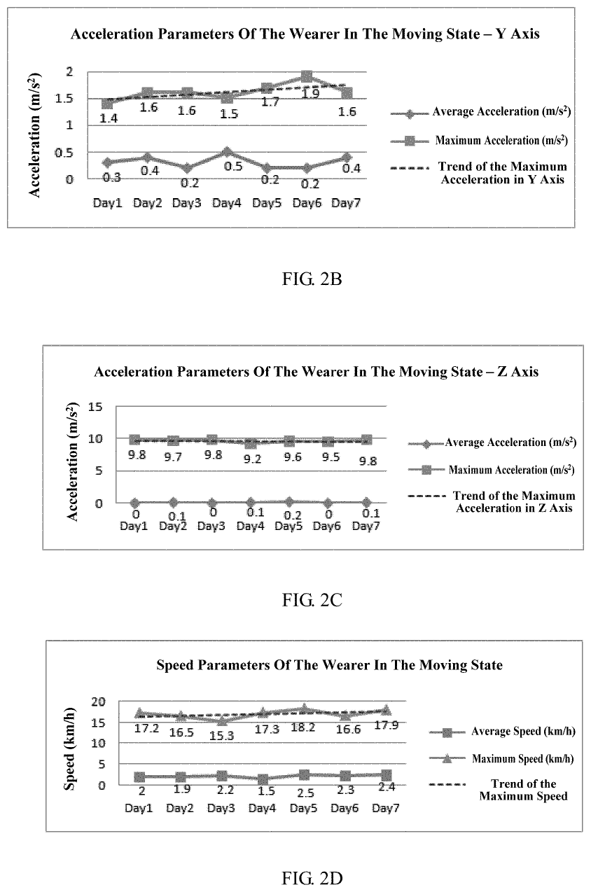

FIG. 2A shows a changing trend diagram of acceleration in the x-axis direction in a preset statistical period according to an embodiment of the present disclosure. For each time intervals of each days, the maximum value and the average value of the acceleration data in the x-axis direction in the time interval can be calculated according to the data of a plurality of accelerations in the x-axis direction collected in the time interval. FIG. 2A shows the average acceleration, the maximum acceleration, and the linear trend of the maximum acceleration in the x-axis direction in the same time interval (for example, the time interval 11:00˜13:00 for exercises) in the 7 days (i.e., data valid period), and it can be derived from the linear trend that the predicted maximum value of the acceleration in the x-axis direction in the same time interval of the 8th day is 1.475 m/s2.

FIG. 2B shows a changing trend diagram of acceleration in the y-axis direction in a preset statistical period according to an embodiment of the present disclosure. For each time intervals of each days, the maximum value and the average value of the acceleration data in the y-axis direction in the time interval can be calculated according to a plurality of acceleration data in the y-axis direction collected in the time interval. FIG. 2B shows the average acceleration, the maximum acceleration, and the linear trend of the maximum acceleration in the y-axis direction in the same time interval (for example, the time interval 11:00˜13:00 for exercises) in the 7 days (i.e., data valid period), and it can be derived from the linear trend that the predicted maximum value of the acceleration in the y-axis direction in the same time interval on the eighth day is 1.6143 m/s2.

FIG. 2C shows a changing trend diagram of acceleration in the z-axis direction in a preset statistical period according to an embodiment of the present disclosure. For each time intervals of each days, the maximum value and the average value of the acceleration data in the z-axis direction in the time interval can be calculated according to the data of a plurality of accelerations in the z-axis direction collected in the time interval. FIG. 2C shows the average acceleration, the maximum acceleration, and the linear trend of the maximum acceleration in the z-axis direction in the same time interval (for example, the time interval 11:00˜13:00 for exercises) in the 7 days (i.e., data valid period), and it can be derived from the linear trend that the predicted maximum value of the acceleration in the z-axis direction in the same time interval of the 8th day is 9.6929 m/s2.

Further, the speed of the user can be obtained by integrating the acceleration data in the x-axis direction, the y-axis direction and the z-axis direction. FIG. 2D shows a changing trend diagram of the speed of the user in a preset statistical period according to an embodiment of the present disclosure. For each time intervals of each days, the maximum value and the average value of the speed in the time interval can be calculated according to a plurality of speeds in the time interval. FIG. 2D shows the average speed, the maximum speed, and the linear trend of the maximum speed in the same time interval (for example, the time interval 11:00˜13:00 for exercises) in the 7 days (i.e., data valid period), and it can be derived from the linear trend that the predicted maximum value of the speeds of the user in the same time interval on the eighth day is 16.4427 km/h.

Thus, with respect to different users, the movement data are collected by the inertial sensor in the wearable device after the user wears the wearable device, a movement characteristic curve of the monitored person corresponding to the changing trend of the movement data in the normal moving state in the previous preset counting cycles is calculated according to the historical movement data, a data template corresponding to the user is obtained, and corresponding prediction data can be obtained by continuously learning the data template.

In Example 1, the Step S130 of judging whether the user has an abnormal behavior according to the real-time movement data, the predictive indicator acquired in the data indicator acquiring phase and a preset strategy comprises: obtaining a real-time speed of the user by calculating according to the accelerations/acceleration in the x-axis direction, the y-axis direction and/or the z-axis direction of the user monitored in real time; and when a magnitude of the acceleration in the z-axis direction monitored in real time exceeds the predicted maximum value of the acceleration in the z-axis direction, the direction of the acceleration in the z-axis direction monitored in real time changes from the positive direction of the z-axis direction to the negative direction of the z-axis direction, and the real-time speed of the user becomes 0 and has been maintained for a predetermined duration, determining that the user has fallen

In other words, in the process of monitoring the user behavior by the wearable device, when it is monitored that the magnitude of the vertically downward acceleration of the user exceeds the predicted maximum value of the acceleration in the direction which is predicted according to the historical movement data, it indicates that the user suddenly accelerates downwardly. When it is monitored that the direction of acceleration is changed from downward to upward, it indicates that the movement stops abruptly. When it is monitored that the speed of the user maintains 0 for a certain period of time, it indicates that there is no movement for a certain period of time after the movement stops abruptly. When the above situations all happen, it is determined that the user has fallen.

Further, in Example 2, the inertial sensor in the wearable device comprises a gyroscope in addition to the accelerometer; and after the user wears the wearable device, the accelerometer is configured to collect accelerations/an acceleration in an x-axis direction, a y-axis direction and/or a z-axis direction of the user, and the gyroscope is configured to collect rotational angular velocities/a rotational angular velocity about the x-axis direction, the y-axis direction and/or the z-axis direction of the user.

In Example 2, the Step S130 of judging whether the user has an abnormal behavior according to the real-time movement data, the predictive indicator acquired in the data indicator acquiring phase and a preset strategy comprises: obtaining a real-time speed of the user by calculating according to the accelerations/acceleration in the x-axis direction, the y-axis direction and/or the z-axis direction of the user monitored in real time; obtaining a real-time tilt angle of the user by calculating according to the rotational angular velocities/rotational angular velocity about the x-axis direction, the y-axis direction and/or the z-axis direction of the user monitored in real time; and when a magnitude of the acceleration in the z-axis direction monitored in real time exceeds the predicted maximum value of the acceleration in the z-axis direction, the direction of the acceleration in the z-axis direction monitored in real time changes from the positive direction of the z-axis direction to the negative direction of the z-axis direction, the real-time speed of the user becomes 0 and has been maintained for a predetermined duration, and the real-time tilt angle of the user exceeds a predetermined angle, determining that the user has fallen.

In other words, in the process of monitoring the user behavior by the wearable device, when it is monitored that the user suddenly accelerates downwardly, the movement stops abruptly, there is no movement for a certain period of time after the movement stops abruptly, and the inclination angle of the user also exceeds the normal range in the time period when the above situations all happen, it is determined that the user has fallen. Compared with the judgment rules of Example 1, the judgment rules of Example 2 have one more condition (i.e., the inclination angle of the user), so the falling behavior can be judged more accurately.

On the basis of the above Example 1 or Example 2, the wearable device of the present solution may be further provided with a barometer. When the user has worn the wearable device, the altitude of the user is monitored in real time through the barometer; then the Step S130 of judging whether the user has an abnormal behavior according to the real-time movement data, the predictive indicator acquired in the data indicator acquiring phase and a preset strategy further comprises: after determining that the user has fallen, further judging whether a decrease in the altitude of the user monitored in real time exceeds a predetermined threshold, and if yes, determining that the user has dropped from a high place.

In other words, after determining that the user has fallen by the judgment rules of the above Example 1 or Example 2, the severity of the falling behavior should be further judged. It can be judged whether the user has fallen from an altitude beyond the safe range according to the altitude data monitored by the barometer. If yes, it is determined that the user's falling behavior is a drop from a high place, a more urgent response mechanism must be adopted.

When it is determined that the user has fallen or drops from a high place, an emergency help SMS (Short Message Service) is sent to 120 (the emergency number) or an emergency contact person through the GSM (Global System for Mobile Communication) network of the wearable device, wherein the short message may indicate the type of accident and the location of the accident, and an SOS help sound may be played at a certain frequency. The falling behavior or the high place drop behavior may be distinguished by different security levels of emergency calls or alarms.

In an embodiment of the present disclosure, the preset statistical period consists of N consecutive sub-periods preceding the current sub-period, wherein N is a positive integer greater than 1. The method shown in FIG. 1 further comprises: when an earliest collecting time of the historical movement data is not within the N consecutive sub-periods, deleting the historical movement data collected before the N consecutive sub-periods.

For example, the preset statistical period is 7 days. When the collecting time corresponding to the movement data stored in the wearable device exceeds 7 days, some data need to be deleted to release the resource space of the wearable device. Therefore, the movement data collected on the earliest day and stored in the wearable device may be all deleted, or at most only the statistical result values of the earliest collected movement data, such as the maximum value, the minimum value, and/or the average value, are kept. That is, all movement data are deleted according to a first-in first-out queue rule.

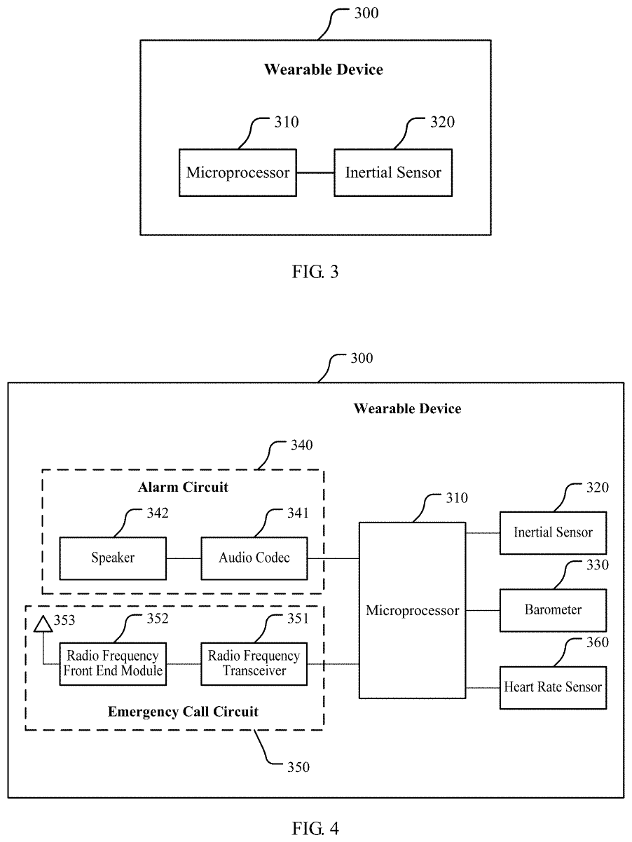

FIG. 3 shows a schematic diagram of a wearable device according to an embodiment of the present disclosure. As shown in FIG. 3, the wearable device 300 comprises a microprocessor 310 and an inertial sensor 320.

The inertial sensor 320 is configured to, after a user has worn the wearable device 300, collect historical movement data of the user in a preset statistical period, and collect real-time movement data of the user. The historical movement data and the real-time movement data are relative terms, wherein the historical movement data refer to the movement data collected in the preset statistical period before the current moment, while the real-time movement data refer to the movement data collected at the current moment. The current real-time movement data may be used as the historical movement data at a later time.

The microprocessor 310 is connected to the inertial sensor 320, and is configured to acquire a predictive indicator according to a changing trend of the historical movement data; judge whether the user has an abnormal behavior according to the real-time movement data, the predictive indicator acquired in the data indicator acquiring phase and a preset strategy; and send an alarm notification when it is determined that the user has an abnormal behavior.

Thus, the wearable device shown in FIG. 3 monitors the movement data of the user. For the current moment, the movement data collected by the wearable device in the previous preset statistical period are used as the historical movement data, and the movement data collected in real time by the wearable device at the current moment are used as the real-time movement data. The predictive indicator is acquired according to the change rule of the historical movement data, it is judged according to the real-time movement data, the predictive indicator and a preset strategy whether the user has an abnormal behavior, and an alarm is sent when the judging result is yes. Thereby the monitoring of the behavior of a user wearing a wearable device can be achieved.

The technical solution can use the historical movement data of each user as the template data of self-learning with respect to different users, and obtain the predictive indicator of the movement at a later time of the user by continuous learning of the template data, and can analyze and discover an abnormal behavior of the user by combining the theoretical predictive indicator and the real-time movement data actually collected at the current moment. Thereby the customized and high accuracy behavior monitoring can be realized.

In an embodiment of the present disclosure, the inertial sensor 320 comprises an accelerometer configured to collect accelerations/an acceleration in an x-axis direction, a y-axis direction and/or a z-axis direction of the user, and the microprocessor 310 is connected to the accelerometer and is configured to process the accelerations/acceleration in the x-axis direction, the y-axis direction and/or the z-axis direction collected by the accelerometer. The gravity vector direction is the z-axis direction, a directly forward direction of the user is the x-axis direction, and the y-axis, the x-axis, and the z-axis constitute a right-handed coordinate system, wherein the right-handed coordinate system changes as the user moves. The same applies hereinafter.

Further, in another embodiment of the present disclosure, the inertial sensor 320 comprises not only an accelerometer but also a gyroscope configured to collect rotational angular velocities/a rotational angular velocity about the x-axis direction, the y-axis direction and/or the z-axis direction of the user. The microprocessor 310 is connected to the accelerometer and is configured to process the accelerations/acceleration in the x-axis direction, the y-axis direction and/or the z-axis direction collected by the accelerometer. The microprocessor 310 is also connected to the gyroscope and is also configured to process the rotational angular velocities/rotational angular velocity in the x-axis direction, the y-axis direction and/or the z-axis direction collected by the gyroscope.

FIG. 4 shows a schematic diagram of a wearable device according to another embodiment of the present disclosure. As shown in FIG. 4, the wearable device 300 comprises a microprocessor 310, an inertial sensor 320, a barometer 330, an alarm circuit 340, an emergency call circuit 350, and a heart rate sensor 360.

The inertial sensor 320 comprises an accelerometer configured to collect accelerations/an acceleration in an x-axis direction, a y-axis direction and/or a z-axis direction of the user, and a gyroscope configured to collect rotational angular velocities/a rotational angular velocity about the x-axis direction, the y-axis direction and/or the z-axis direction of the user. The microprocessor 310 is connected to the accelerometer and the gyroscope to process the acceleration data collected by the accelerometer and the rotational angular velocity data collected by the gyroscope.

The barometer 330 is configured to monitor an altitude of the user. The microprocessor 310 is connected to the barometer 330, and is configured to process the altitude data monitored by the barometer 330.

The alarm circuit 340 comprises an audio codec 341 and a speaker 342. The microprocessor 310 is connected to the alarm circuit 340, and is configured to control the speaker 342 to produce a sound through the audio codec 341.

The emergency call circuit 350 comprises a radio frequency transceiver 351, a radio frequency front end module 352, and a radio frequency antenna 353. The microprocessor 310 is connected to the emergency call circuit 350, and is configured to receive or transmit radio frequency signals through the emergency call circuit 350.

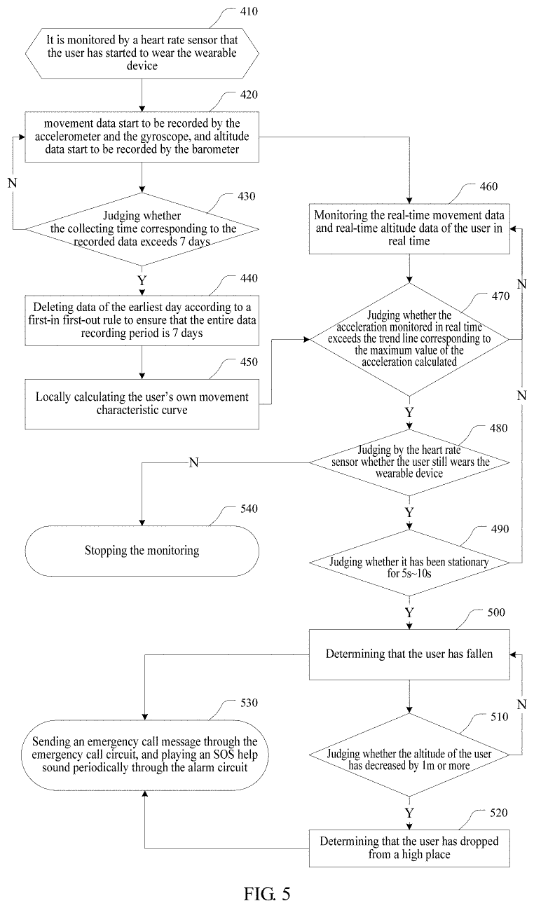

The working principle of the wearable device shown in FIG. 4 is described with reference to FIG. 5. FIG. 5 shows a flow chart of monitoring the user behavior by a wearable device according to an embodiment of the present disclosure, and describes the specific operations of the components in the wearable device shown in FIG. 4 from the perspective of a microprocessor in the wearable device. The working process of the wearable device comprises the following steps.

In Step S410, it is monitored by a heart rate sensor that the user has started to wear the wearable device.

That is, when the heart rate sensor has monitored the user's heart rate data, the microprocessor determines that the user has worn the wearable device.

In Step S420, movement data start to be recorded by the accelerometer and the gyroscope, and altitude data start to be recorded by the barometer.

The movement data recording in this Step is divided into two branches: one is from Step S430 to Step S450 to show the remaining and processing of the historical movement data, and the other is Step S460 to show the current real-time monitored movement data.

In Step S430, judging whether the collecting time corresponding to the recorded data exceeds 7 days. If yes, Step S440 is performed; otherwise Step S420 is performed. In the present embodiment, 7 days is a preset statistical period.

In Step S440, deleting data of the earliest day according to a first-in first-out (FIFO) rule to ensure that the entire data recording period is 7 days.

In Step S450, locally calculating the user's own movement characteristic curve.

Specifically, the changing trend of the movement data in 7 days is obtained according to the recorded movement data in 7 days. For specific movement data, the maximum value, the minimum value and/or the average value of the specific movement data in the same time interval of each day in 7 days are calculated, and the changing curve of the maximum value, the changing curve of the minimum value, and/or the changing curve of the average value of the specific movement data in the same time interval in 7 days are further obtained. The trend lines of the maximum value, the minimum value, and/or the average value of the specific movement data can be predicted according to these changing curves, and are taken as the user's own movement characteristic curves.

In Step S460, monitoring the real-time movement data and real-time altitude data of the user in real time.

In Step S470, judging whether the acceleration monitored in real time in Step S460 exceeds the trend line corresponding to the maximum value of the acceleration calculated in Step S450. If yes, Step S480 is performed; otherwise Step S460 is performed again.

In Step S480, judging by the heart rate sensor whether the user still wears the wearable device. If yes, Step S490 is performed; otherwise Step S540 is performed.

In Step S490, judging whether it has been stationary for 5 s˜10 s. If yes, Step S500 is performed; otherwise Step S460 is continued.

Specifically, a real-time speed of the user is obtained by the integration of the acceleration monitored in real time, and the judgment result is yes when the real-time speed of the user is 0 and has been maintained for 5 s˜10 s.

In Step S500, determining that the user has fallen.

In Step S510, judging whether the altitude of the user has decreased by 1 m or more. If yes, Step S520 is performed; otherwise Step S500 is performed again.

In Step S520, determining that the user has dropped from a high place.

In Step S530, sending an emergency call message through the emergency call circuit, and playing an SOS help sound periodically through the alarm circuit.

The Step S530 may also be directly performed after the Step 500.

In Step S540, stopping the monitoring.

Thus, the wearable device shown in FIG. 4 can construct different template data (historical movement data) with respect to different users, and can continuously learn in the subsequent process, so it is more targeted, and can also improve the accuracy in monitoring. The movement characteristics of the monitored person are collected and analyzed and thus the movement trend curve is obtained by calculation. The data monitored in real time are compared with the analysis data of the monitored person, so it is more targeted and improves the accuracy.

In the foregoing embodiments, the wearable device may be a smart watch, a smart wristband, or other type of wearable devices, which is not limited herein.

It should be noted that the embodiments of the working principle of the wearable device shown in FIG. 3 and FIG. 4 are corresponding to the embodiments shown in FIG. 1 and FIG. 2, and the same parts will not be repeated herein.

In sum, the technical solutions provided by the present disclosure monitor the movement data of the user by the wearable device. For the current moment, the movement data collected by the wearable device in the previous preset statistical period are used as the historical movement data, and the movement data collected in real time by the wearable device at the current moment are used as the real-time movement data. The predictive indicator is acquired according to the change rule of the historical movement data, it is judged whether the user has an abnormal behavior according to the real-time movement data, the predictive indicator and a preset strategy, and an alarm is sent when the judging result is yes. Thereby the monitoring of the behavior of a user wearing a wearable device can be achieved.

The technical solutions can use the historical movement data of each user as the template data of self-learning with respect to different users, and obtain the predictive indicator of the movement at a later time of the user by continuous learning of the template data, and can analyze and discover an abnormal behavior of the user by combining the theoretical predictive indicator and the real-time movement data actually collected at the current moment. Thereby the customized and high accuracy behavior monitoring can be realized.

The above is only preferred embodiments of the present disclosure and is not intended to limit the scope of the present disclosure. Any modifications, equivalent substitutions, improvements, etc. made within the spirit and scope of the present disclosure should be included in the scope of the present disclosure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A user behavior monitoring method, comprising:
providing an inertial sensor in a wearable device;
at the beginning of each data indicator acquiring phases, after a user has worn the wearable device, monitoring and collecting historical movement data of the user in a preset statistical period by the inertial sensor, and acquiring a predictive indicator according to a changing trend of the historical movement data;
in real-time monitoring, collecting real-time movement data of the user, and judging whether the user has an abnormal behavior according to the real-time movement data, the predictive indicator acquired in the data indicator acquiring phase and a preset strategy;
sending an alarm notification when it is determined that the user has an abnormal behavior;
wherein the preset statistical period consists of a plurality of sub-periods;
the step of collecting historical movement data of the user in a preset statistical period comprises: collecting movement data in each sub-period in the preset statistical period;
the step of acquiring a predictive indicator according to a changing trend of the historical movement data comprises: acquiring the predictive indicator in a current sub-period according to the changing trend of the movement data in a plurality of consecutive sub-periods; and
the step of collecting real-time movement data of the user comprises: collecting real-time movement data in the current sub-period.

2. (canceled)

3. The method according to claim 1, wherein each sub-period consists of a plurality of time intervals;
the step of acquiring the predictive indicator in a current sub-period according to the changing trend of the movement data in a plurality of consecutive sub-periods comprises:
acquiring movement data in a specified time interval of each sub-period; and
predicting the predictive indicator in the specified time interval in the current sub-period according to a changing trend of the movement data in the specified time intervals in the plurality of sub-periods; and
the step of collecting real-time movement data in the current sub-period comprises:
collecting real-time movement data in the specified time interval in the current sub-period.

4. The method according to claim 1, wherein the step of judging whether the user has an abnormal behavior according to the real-time movement data, the predictive indicator acquired in the data indicator acquiring phase and a preset strategy comprises:
calculating a relevant parameter of the real-time movement data according to the real-time movement data; and
comparing the real-time movement data with the predictive indicator, and determining that the user has an abnormal behavior when the real-time movement data exceed a predetermined range of the predictive indicator and one of the following conditions is satisfied:
the real-time movement data satisfy a predetermined condition;
the relevant parameter of the real-time movement data satisfies a predetermined condition; or
the real-time movement data and the relevant parameter of the real-time movement data satisfy a predetermined condition.

5. The method according to claim 4, wherein the inertial sensor comprises: an accelerometer configured to collect accelerations/an acceleration in an x-axis direction, a y-axis direction and/or a z-axis direction of the user;
the step of acquiring a predictive indicator according to a changing trend of the historical movement data comprises: acquiring a predicted maximum value, a predicted minimum value, and/or a predicted average value of the accelerations/acceleration in the x-axis direction, the y-axis direction and/or the z-axis direction according to a changing trend of the accelerations/acceleration in the x-axis direction, the y-axis direction and/or the z-axis direction in a preset statistical period; and
the step of judging whether the user has an abnormal behavior according to the real-time movement data, the predictive indicator acquired in the data indicator acquiring phase and a preset strategy comprises:
obtaining a real-time speed of the user by calculating according to the accelerations/acceleration in the x-axis direction, the y-axis direction and/or the z-axis direction of the user monitored in real time; and
when a magnitude of the acceleration in the z-axis direction monitored in real time exceeds the predicted maximum value of the acceleration in the z-axis direction, the direction of the acceleration in the z-axis direction monitored in real time changes from the positive direction of the z-axis direction to the negative direction of the z-axis direction, and the real-time speed of the user becomes 0 and has been maintained for a predetermined duration, determining that the user has fallen;
wherein a gravity vector direction is the z-axis direction, a directly forward direction of the user is the x-axis direction, and the y-axis, the x-axis, and the z-axis constitute a right-handed coordinate system, wherein the right-handed coordinate system changes as the user moves.

6. The method according to claim 5, wherein the inertial sensor further comprises: a gyroscope configured to collect rotational angular velocities/a rotational angular velocity about the x-axis direction, the y-axis direction and/or the z-axis direction of the user; and
the step of judging whether the user has an abnormal behavior according to the real-time movement data, the predictive indicator acquired in the data indicator acquiring phase and a preset strategy comprises:
obtaining a real-time speed of the user by calculating according to the accelerations/acceleration in the x-axis direction, the y-axis direction and/or the z-axis direction of the user monitored in real time;
obtaining a real-time tilt angle of the user by calculating according to the rotational angular velocities/rotational angular velocity about the x-axis direction, the y-axis direction and/or the z-axis direction of the user monitored in real time; and
when a magnitude of the acceleration in the z-axis direction monitored in real time exceeds the predicted maximum value of the acceleration in the z-axis direction, the direction of the acceleration in the z-axis direction monitored in real time changes from the positive direction of the z-axis direction to the negative direction of the z-axis direction, the real-time speed of the user becomes 0 and has been maintained for a predetermined duration, and the real-time tilt angle of the user exceeds a predetermined angle, determining that the user has fallen.

7. The method according to claim 5, further comprising:
providing a barometer in the wearable device, and monitoring an altitude of the user in real time by the barometer after the user wears the wearable device;
the step of judging whether the user has an abnormal behavior according to the real-time movement data, the predictive indicator acquired in the data indicator acquiring phase and a preset strategy further comprises:
after determining that the user has fallen, further judging whether a decrease in the altitude of the user monitored in real time exceeds a predetermined threshold, and if yes, determining that the user has dropped from a high place.

8. The method according to claim 1, wherein the preset statistical period consists of N consecutive sub-periods preceding the current sub-period, wherein N is a positive integer greater than 1; and
the method further comprises: when an earliest collecting time of the historical movement data is not within the N consecutive sub-periods, deleting the historical movement data collected before the N consecutive sub-periods.

9. A wearable device, comprising: an inertial sensor and a microprocessor, wherein
the inertial sensor is configured to, after a user has worn the wearable device, collect historical movement data of the user in a preset statistical period, and collect real-time movement data of the user; and
the microprocessor is connected to the inertial sensor, and is configured to acquire a predictive indicator according to a changing trend of the historical movement data; judge whether the user has an abnormal behavior according to the real-time movement data, the predictive indicator acquired in the data indicator acquiring phase and a preset strategy; and send an alarm notification when it is determined that the user has an abnormal behavior;
wherein the preset statistical period consists of a plurality of sub-periods;
the step of collecting historical movement data of the user in a preset statistical period comprises: collecting movement data in each sub-period in the preset statistical period;
the step of acquiring a predictive indicator according to a changing trend of the historical movement data comprises: acquiring the predictive indicator in a current sub-period according to the changing trend of the movement data in a plurality of consecutive sub-periods; and
the step of collecting real-time movement data of the user comprises: collecting real-time movement data in the current sub-period.

10. The wearable device according to claim 9, the wearable device further comprises an alarm circuit, wherein the alarm circuit comprises an audio codec and a speaker; and
the microprocessor is connected to the alarm circuit and is configured to control the speaker to produce a sound through the audio codec.

11. The wearable device according to claim 9, the wearable device further comprises an emergency call circuit, wherein the emergency call circuit comprises a radio frequency transceiver, a radio frequency front end module and a radio frequency antenna; and
the microprocessor is connected to the emergency call circuit and is configured to receive or transmit radio frequency signals through the emergency call circuit.

12. The wearable device of claim 9, wherein the inertial sensor comprises an accelerometer configured to collect accelerations/an acceleration in an x-axis direction, a y-axis direction and/or a z-axis direction of the user;
the microprocessor is connected to the accelerometer and is configured to process the accelerations/acceleration in the x-axis direction, the y-axis direction and/or the z-axis direction collected by the accelerometer; wherein
the step of acquiring a predictive indicator according to a changing trend of the historical movement data comprises: acquiring a predicted maximum value, a predicted minimum value, and/or a predicted average value of the accelerations/acceleration in the x-axis direction, the y-axis direction and/or the z-axis direction according to a changing trend of the accelerations/acceleration in the x-axis direction, the y-axis direction and/or the z-axis direction in a preset statistical period; and
the step of judging whether the user has an abnormal behavior according to the real-time movement data, the predictive indicator acquired in the data indicator acquiring phase and a preset strategy comprises:
obtaining a real-time speed of the user by calculating according to the accelerations/acceleration in the x-axis direction, the y-axis direction and/or the z-axis direction of the user monitored in real time; and
when a magnitude of the acceleration in the z-axis direction monitored in real time exceeds the predicted maximum value of the acceleration in the z-axis direction, the direction of the acceleration in the z-axis direction monitored in real time changes from the positive direction of the z-axis direction to the negative direction of the z-axis direction, and the real-time speed of the user becomes 0 and has been maintained for a predetermined duration, determining that the user has fallen;
wherein a gravity vector direction is the z-axis direction, a directly forward direction of the user is the x-axis direction, and the y-axis, the x-axis, and the z-axis constitute a right-handed coordinate system, wherein the right-handed coordinate system changes as the user moves.

13. The wearable device according to claim 9, wherein a heart rate sensor configured to monitor whether the user wears the wearable device is further provided within the wearable device, and the microprocessor is connected to the heart rate sensor.

14. The wearable device according to claim 12, wherein the inertial sensor further comprises: a gyroscope configured to collect rotational angular velocities/a rotational angular velocity about the x-axis direction, the y-axis direction and/or the z-axis direction of the user; and the microprocessor is connected to the gyroscope and is also configured to process the rotational angular velocities/rotational angular velocity in the x-axis direction, the y-axis direction and/or the z-axis direction collected by the gyroscope; wherein
the step of judging whether the user has an abnormal behavior according to the real-time movement data, the predictive indicator acquired in the data indicator acquiring phase and a preset strategy comprises:
obtaining a real-time speed of the user by calculating according to the accelerations/acceleration in the x-axis direction, the y-axis direction and/or the z-axis direction of the user monitored in real time;
obtaining a real-time tilt angle of the user by calculating according to the rotational angular velocities/rotational angular velocity about the x-axis direction, the y-axis direction and/or the z-axis direction of the user monitored in real time; and
when a magnitude of the acceleration in the z-axis direction monitored in real time exceeds the predicted maximum value of the acceleration in the z-axis direction, the direction of the acceleration in the z-axis direction monitored in real time changes from the positive direction of the z-axis direction to the negative direction of the z-axis direction, the real-time speed of the user becomes 0 and has been maintained for a predetermined duration, and the real-time tilt angle of the user exceeds a predetermined angle, determining that the user has fallen.

15. The wearable device according to claim 12, wherein the wearable device further comprises a barometer configured to monitor an altitude of the user; and the microprocessor is connected to the barometer and is also configured to process altitude data collected by the barometer; wherein
the step of judging whether the user has an abnormal behavior according to the real-time movement data, the predictive indicator acquired in the data indicator acquiring phase and a preset strategy further comprises:
after determining that the user has fallen, further judging whether a decrease in the altitude of the user monitored in real time exceeds a predetermined threshold, and if yes, determining that the user has dropped from a high place.

16. The wearable device according to claim 9, wherein each sub-period consists of a plurality of time intervals;
the step of acquiring the predictive indicator in a current sub-period according to the changing trend of the movement data in a plurality of consecutive sub-periods comprises:
acquiring movement data in a specified time interval of each sub-period; and
predicting the predictive indicator in the specified time interval in the current sub-period according to a changing trend of the movement data in the specified time intervals in the plurality of sub-periods; and
the step of collecting real-time movement data in the current sub-period comprises: collecting real-time movement data in the specified time interval in the current sub-period.

17. The wearable device according to claim 9, wherein the step of judging whether the user has an abnormal behavior according to the real-time movement data, the predictive indicator acquired in the data indicator acquiring phase and a preset strategy comprises:
calculating a relevant parameter of the real-time movement data according to the real-time movement data; and
comparing the real-time movement data with the predictive indicator, and determining that the user has an abnormal behavior when the real-time movement data exceed a predetermined range of the predictive indicator and one of the following conditions is satisfied:
the real-time movement data satisfy a predetermined condition;
the relevant parameter of the real-time movement data satisfies a predetermined condition; or
the real-time movement data and the relevant parameter of the real-time movement data satisfy a predetermined condition.

18. The wearable device according to claim 9, wherein the preset statistical period consists of N consecutive sub-periods preceding the current sub-period, wherein N is a positive integer greater than 1; and
the method further comprises: when an earliest collecting time of the historical movement data is not within the N consecutive sub-periods, deleting the historical movement data collected before the N consecutive sub-periods.
